(19) United States
(12) Patent Application Publication
(10) Pub. No.: US 2025/0067425 A1
(43) Pub. Date: Feb. 27, 2025

(54) WATERPROOF LAMP HOLDER AND WATERPROOF BULB

(71) Applicant: Shenzhen Puli Lighting Co., LTD., Shenzhen (CN)

(72) Inventor: Hailong Su, Shenzhen (CN)

(73) Assignee: Shenzhen Puli Lighting Co., LTD., Shenzhen, Guangdong (CN)

(21) Appl. No.: 18/242,609

(22) Filed: Sep. 6, 2023

(30) Foreign Application Priority Data
Aug. 22, 2023 (CN) 202322265354.6

(51) Int. Cl. F21V 31/00; F21V 17/06; F21V 23/00

(52) U.S. Cl. CPC F21V 31/005; F21V 17/06; F21V 23/006; F21Y 2115/10

(57) ABSTRACT

Provided are a waterproof lamp holder and a waterproof bulb. The waterproof lamp holder comprises a main body and a PCB board; a mounting groove with an opening at one end is formed on the main body; the main body is an elastically deformable soft structural member; the PCB board is installed in the mounting groove; the PCB board has two conductive pins and two output ends, and the conductive pin is embedded in a groove bottom or groove wall of the mounting groove and extends out of the main body to be connected with an external power supply; the output end passes through the opening of the mounting groove and extends out of the mounting groove. Because there is no guide hole arranged on the main body, the conductive pin can directly pierce the bottom or wall of the mounting groove to connect with an external power supply.

### CROSS REFERENCE TO RELATED APPLICATIONS

The present application claims the benefit of Chinese Patent Application No. 202322265354.6 filed on Aug. 22, 2023, the contents of which are incorporated herein by reference in their entirety.

### TECHNICAL FIELD

The present application relates to the field of lighting equipment, in particular to a waterproof lamp holder and a waterproof bulb.

### BACKGROUND

Waterproof light bulb, as a kind of lighting fixture with waterproof function, provides people with safe and stable lighting in various extreme environments and other harsh conditions. In the prior art, the waterproof bulb with waterproof function has weak waterproof ability at the position of the lamp holder, because the lamp holder has a guide hole for PCB board pins to pass through, which affects the sealing performance of the lamp holder, water can enter the lamp holder through the guide hole, thus causing waterproof failure of the lamp.

### SUMMARY

The embodiment of the present application provides a waterproof lamp holder and a waterproof bulb, aiming at solving the problem of waterproof failure of lamps caused by water leakage of the lamp holder.

The embodiment of the present application provides a waterproof lamp holder, which includes a main body and a PCB board; a mounting groove with an opening at one end is formed on the main body; the main body is an elastically deformable soft structural member; the PCB board is installed in the mounting groove; the PCB board has two conductive pins and two output ends, and the conductive pin is embedded in a groove bottom or groove wall of the mounting groove and extends out of the main body to be connected with an external power supply; the output end passes through the opening of the mounting groove and extends out of the mounting groove.

Optionally, the PCB board is provided with a bridge rectifier, the bridge rectifier is used for converting external alternating current into direct current; two ends of the bridge rectifier are electrically connected with the conductive pin and the output end respectively.

Optionally, the model of the bridge rectifier is MB10F.

Optionally, the main body is a silica gel piece or a rubber piece.

The present application also provides a waterproof light bulb, which includes a bulb housing, an illuminant and a waterproof lamp holder described above. The illuminant is electrically connected with the PCB board, the illuminant is arranged in the bulb housing, and the bulb housing is detachably connected with the waterproof lamp holder.

Optionally, a top end of the bulb housing is provided with a mounting opening, and an end of the main body extending out of the output end is inserted into the mounting opening and is in interference fit with the mounting opening.

Optionally, the illuminant has a first connection end and a second connection end, and the first connection end and the second connection end are each electrically connected with one output end.

Optionally, the illuminant is one of LED copper wire light, LED strip and light guide column.

Optionally, the waterproof bulb further includes a lamp head, the lamp head is covering the waterproof lamp holder and connected with the bulb housing; and threads are formed on an outside of the lamp head.

Optionally, the lamp head includes a lamp head body and a lamp head cover, and the threads are formed on the lamp head body; the lamp head body and the lamp head cover are connected through an insulator; one conductive pin is electrically connected with the lamp head body, and another conductive pin is electrically connected with the lamp head cover.

Optionally, the two conductive pins are electrically connected with the lamp head body and the lamp head cover respectively through wires.

### Beneficial Effects

In the waterproof bulb provided by the embodiments of the present application, because there is no guide hole on the main body of the waterproof lamp holder, when installing the PCB board to mounting groove, the conductive pin can directly pierce the groove bottom or groove wall of the mounting groove to connect with an external power supply. Meanwhile, because the main body is a flexible structural member which is elastically deformable, after the conductive pin pierces the main body, the material around the piercing hole tends to return to its original shape, so the conductive pin would be squeezed, and then the main body and the conductive pin may be closely attached to prevent water from entering the lamp holder, thus avoiding the waterproof failure of the lamp.

### BRIEF DESCRIPTION OF THE DRAWINGS

In order to explain the technical solution of the embodiments of this application more clearly, the drawings described in the description of the embodiments of this application will be briefly introduced below. Obviously, the drawings in the present application and their accompanying detailed description are directed to merely exemplary embodiments of the application. For those of ordinary skill in this field, other drawings may be obtained according to these drawings without any creative effort.

FIG. 1 is a schematic sectional view of a waterproof lamp holder according to an embodiment of the present application;

FIG. 2 is a schematic sectional view of a waterproof lamp holder according to an embodiment of the present application;

FIG. 3 is a structural schematic diagram of PCB board in a waterproof lamp holder according to an embodiment of the present application;

FIG. 4 is a schematic sectional view of a waterproof bulb according to an embodiment of the present application;

FIG. 5 is a structural schematic diagram of a waterproof bulb according to an embodiment of the present application;

FIG. 6 is a structural schematic diagram of a waterproof bulb according to an embodiment of the present application.

### REFERENCE SIGNS FOR THE DRAWINGS ARE AS FOLLOW

100. Main body; 110. Mounting groove; 200. Pcb board; 210. Conductive pin; 220. Output end; 230. Bridge rectifier; 300. Bulb housing; 310. Mounting opening; 400. Illuminant; 401. First connection end; 402. Second connection end; 410. Led copper wire light; 420. Led strip; 430. Light guide column; 500. Lamp head; 510. Lamp head body; 520. Lamp head cover.

### DETAILED DESCRIPTION OF DISCLOSED EMBODIMENTS

In order to make the technical problems, technical solutions and beneficial effects of the present application more clear, the application will be further explained in detail below with reference to the drawings and embodiments. It should be understood that the specific embodiments described here are only used to illustrate the application, rather than to limit the application.

In the description of the present application, it is to be understood that the terms “longitudinal”, “radial”, “length”, “width”, “thickness”, “upper”, “lower”, “front”, “rear”, “left”, “right”, “vertical”, “horizontal”, “top”, “bottom”, “inner”, “outer”, and the like indicate an orientation or positional relationship based on that shown in the drawings, and are for convenience of description and simplicity of description only, not intended to indicate or imply that the indicated devices or elements must have a particular orientation, be constructed and operated in a particular orientation, and are therefore not to be construed as limiting the present application.

In the description of the present application, unless otherwise stated, “multiple” means two or more. In the description of the present application, it should be noted that unless otherwise specified and defined, the terms “installation”, “connected with” and “connected to” should be understood in a broad sense. For example, they may be fixedly connected, detachably connected or integrally connected, or may be mechanically connected or electrically connected, or may be directly connected or indirectly connected through an intermediate medium. Or it may be internal communication of two elements. For those of ordinary skill in the art, the specific meanings of the above terms in the present application may be understood in specific situations.

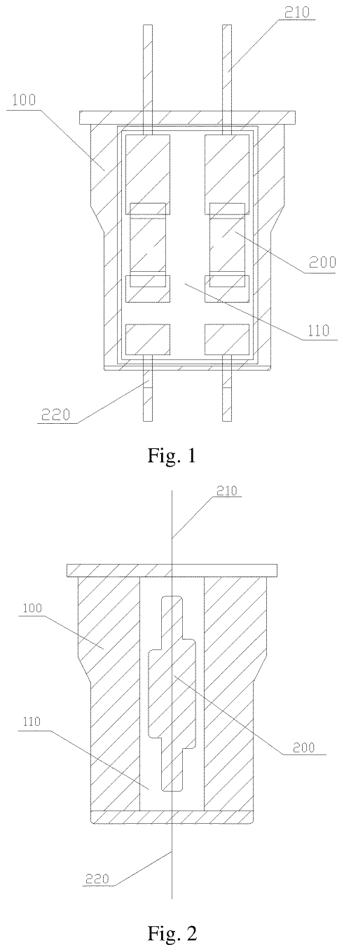

FIG. 1 is a schematic sectional view of a waterproof lamp holder according to an embodiment of the present application. Referring to FIG. 1 and FIGS. 2-6, the embodiment of the present application provides a waterproof lamp holder, including a main body 100 and a PCB board 200; a mounting groove 110 with an opening at one end is formed on the main body 100; the main body 100 is an elastically deformable soft structural member; the PCB board 200 is installed in the mounting groove 110; the PCB board 200 has two conductive pins 210 and two output ends 220, and the conductive pin 210 is embedded in a groove bottom or groove wall of the mounting groove 110 and extends out of the main body 100 to be connected with an external power supply; the output end 200 passes through the opening of the mounting groove 110 and extends out of the mounting groove 110.

In the embodiment of the present application, because there is no guide hole left on the main body 100 of the waterproof lamp holder, when installing the PCB board 200 to the mounting groove 110, the conductive pin 210 can directly pierce the groove bottom or groove wall of the mounting groove 110 to connect with an external power supply. Meanwhile, because the main body 100 is an elastically deformable soft structural member, after the conductive pin 210 pierces the main body 100, the material around the piercing hole tends to return to its original shape, so the conductive pin 210 would be squeezed, and then the main body 100 and the conductive pin 210 may be closely attached to each other, so that water can be prevented from entering the lamp holder, thus avoiding the waterproof failure of the lamp.

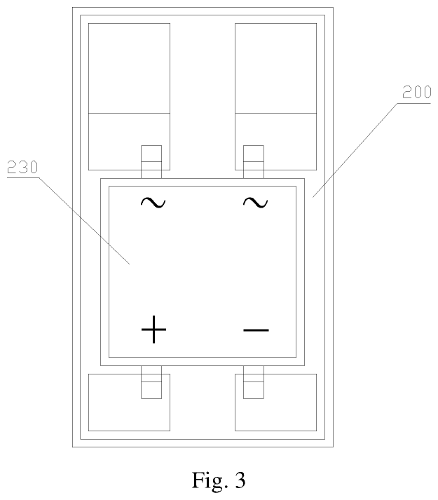

As shown in FIG. 3, in some embodiments, the PCB board 200 is provided with a bridge rectifier 230, which is used to convert external alternating current into direct current; two ends of the bridge rectifier 230 are electrically connected with the conductive pin 210 and the output end 220 respectively. Further, the model of the bridge rectifier 230 is MB10F. Specifically, the bridge rectifier 230 can convert alternating current into direct current, and stabilize the output through the capacitor, so that the illuminant in the waterproof bulb could work in no strobe.

In some embodiments, the main body 100 is a silicone piece. Similarly, the main body 100 may also be made of rubber. This design makes reasonable use of the elastic deformation and waterproof characteristics of silica gel or rubber.

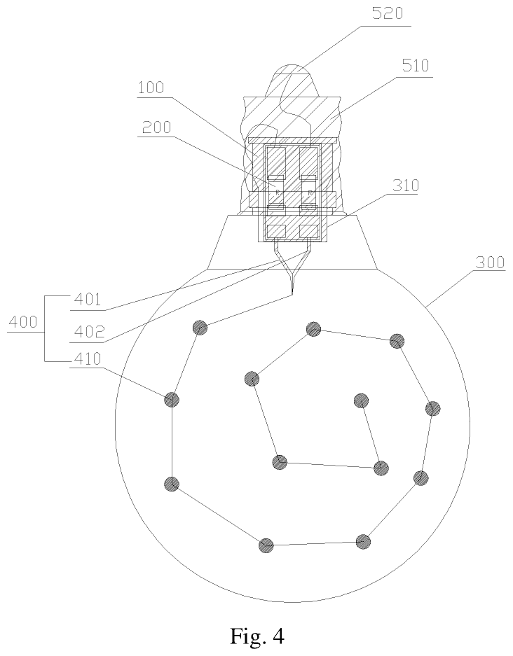

In another aspect, as shown in FIG. 4 to FIG. 6, an embodiment of the present application provides a waterproof light bulb, including a bulb housing 300, an illuminant 400 and a waterproof lamp holder provided by the above embodiments. Hence the waterproof bulb has all the technical effects of the waterproof lamp holder. Illuminant 400 is electrically connected with PCB board 200. The illuminant 400 is arranged in bulb housing 300, and the bulb housing 300 is detachably connected with the waterproof lamp holder. In this embodiment, after the illuminant 400 is electrically connected with the PCB board 200, the alternating current is converted into direct current with constant voltage output through the PCB board 200, hence the illuminant 400 could stably emit light without stroboscopic.

In some embodiments, a top end of the bulb housing 300 is provided with a mounting opening 310, and an end of the main body 100 extending out of the output end 220 is inserted into the mounting opening 310 and is in interference fit with the mounting opening 310. After the main body 100 is inserted into the mounting opening 310, the opening of the mounting groove 110 faces into the bulb housing 300, and the main body 100 is in interference fit with the mounting opening 310. In this way, a closed space is formed between the main body 100 and the bulb housing 300, and water is prevented from entering the bulb housing 300 from the gap between the main body 100 and mounting opening 310, thus the waterproof failure of the lamp can be avoided.

In some embodiments, the illuminant 400 has a first connection end 401 and a second connection end 402, and the first connection end 401 and the second connection end 402 are each electrically connected with one output end 220.

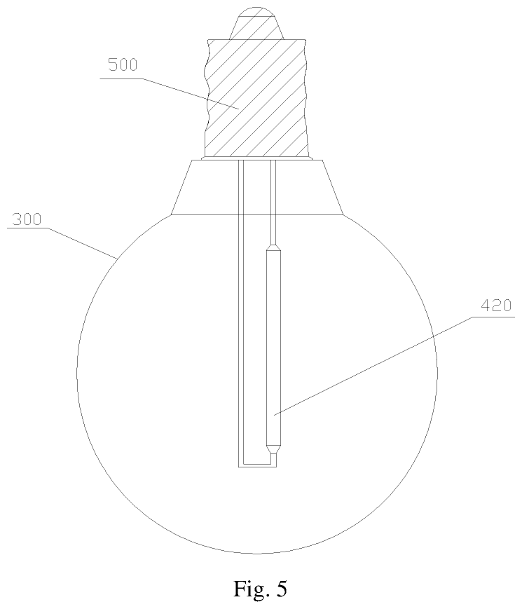

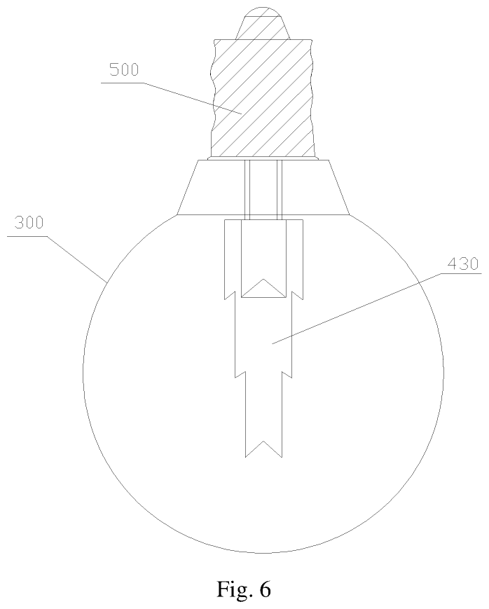

In some embodiments, the illuminant 400 is one of LED copper wire light 410, LED strip 420 and light guide column 430. In the waterproof bulb shown in FIG. 4, the illuminant 400 is LED copper wire light 410. In the waterproof bulb shown in FIG. 5, the illuminant 400 is LED strip 420. In the waterproof bulb shown in FIG. 6, the illuminant 400 is light guide column 430. In this embodiment, various forms of illuminant 400 are provided, and waterproof bulbs containing different illuminant 400 are selected according to specific usage scenarios and requirements.

In some embodiments, the waterproof bulb further includes a lamp head 500, the lamp head 500 is covering the waterproof lamp holder and connected with the bulb housing 300; and threads are formed on an outside of the lamp head 500. Because the waterproof lamp holder and bulb housing 300 are connected merely by interference fit between the main body 100 and mounting opening 310, the main body 100 is likely to fall off during long-term use. After the waterproof lamp holder is covered by the lamp head 500, the lamp head 500 plays a connecting role, and the main body 100 is specifically used for waterproofing, which can significantly improve the waterproof effect.

As shown in FIG. 4, in some embodiments, the lamp head 500 includes a lamp head body 510 and a lamp head cover 520, and threads are formed on the lamp head body 510. The Lamp head body 510 and lamp head cover 520 are connected through an insulator. One conductive pin 210 is electrically connected with the lamp head body 510 through wires, and another conductive pin 210 is electrically connected with the lamp head cover 520 through wires.

The above embodiments are only used to illustrate the technical solutions of this application, but not to limit it. Although the application has been described in detail with reference to the aforementioned embodiments, those of ordinary skill in the art should understand that the technical solutions described in the aforementioned embodiments may still be modified, or some of the technical features may be equivalently replaced. However, these modifications or substitutions do not make the essence of the technical solutions deviate from the spirit and scope of the technical solutions of each embodiment of this application, and shall be included in the protection scope of this application.

1. A waterproof lamp holder, comprising a main body and a PCB board; a mounting groove with an opening at one end is formed on the main body; the main body is an elastically deformable soft structural member; the PCB board is installed in the mounting groove; the PCB board has two conductive pins and two output ends, and the conductive pin is embedded in a groove bottom or groove wall of the mounting groove and extends out of the main body to be connected with an external power supply; the output end passes through the opening of the mounting groove and extends out of the mounting groove; and
the conductive pins directly pierce the groove bottom or groove wall of the mounting groove to enable the PCB board to be installed on the mounting groove; after installation, the main body tightly wraps the conductive pins.

2. The waterproof lamp holder of claim 1, wherein the PCB board is provided with a bridge rectifier, the bridge rectifier is used for converting external alternating current into direct current: two ends of the bridge rectifier are electrically connected with the conductive pin and the output end respectively.

3. The waterproof lamp holder of claim 1, wherein the main body is a silica gel piece or a rubber piece.

4. A waterproof light bulb, comprising a bulb housing, an illuminant and a waterproof lamp holder of claim 1: the illuminant is electrically connected with the PCB board, the illuminant is arranged in the bulb housing, and the bulb housing is detachably connected with the waterproof lamp holder.

5. The waterproof light bulb of claim 4, wherein a top end of the bulb housing is provided with a mounting opening, and an end of the main body extending out of the output end is inserted into the mounting opening and is in interference fit with the mounting opening.

6. The waterproof light bulb of claim 4, wherein the illuminant has a first connection end and a second connection end, and the first connection end and the second connection end are each electrically connected with one output end.

7. The waterproof bulb of claim 4, wherein the illuminant is one of LED copper wire light, LED strip and light guide column.

8. The waterproof bulb of claim 4, wherein the waterproof bulb further comprises a lamp head, the lamp head is covering the waterproof lamp holder and connected with the bulb housing; and threads are formed on an outside of the lamp head.

9. The waterproof bulb of claim 8, wherein the lamp head comprises a lamp head body and a lamp head cover, and the threads are formed on the lamp head body; the lamp head body and the lamp head cover are connected through an insulator; one conductive pin is electrically connected with the lamp head body, and another conductive pin is electrically connected with the lamp head cover.

10. The waterproof light bulb of claim 9, wherein the two conductive pins are electrically connected with the lamp head body and the lamp head cover respectively through wires.
